(19) United States
(12) Patent Application Publication
(10) Pub. No.: US 2004/0085676 A1
(43) Pub. Date: May 6, 2004

(54) Disc cartridge

(75) Inventors: Harumi Aoishi, Odawara-shi (JP); Hideaki Shiga, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/694,215

(22) Filed: Oct. 28, 2003

(30) Foreign Application Priority Data
Oct. 30, 2002 (JP) 316032/2002

(51) Int. Cl. G11B 23/03

(52) U.S. Cl. 360/133

(57) ABSTRACT

A disk cartridge includes a casing, a recording disk, and a liner which is fixed to an inner surface of the casing or a shutter member interposed between the disk and the casing at a site opposed to the disk in order to clean the surface of the disk. The liner is supported away from the inner surface of the casing or the shutter member so that the liner can be deflected when the disk is brought into abutment against the liner due to impact applied to the disk cartridge.

### BACKGROUND OF THE INVENTION

1. Field of the Invention

This invention relates to a disk cartridge, and more particularly to a disk cartridge comprising a casing and a flexible information recording disk housed in the casing.

2. Description of the Related Art

3.5 inch floppy disk cartridges is now prevailing. As shown in FIG. 3A, the floppy disk cartridge 1 comprises a rectangular flat plastic casing 2 and a flexible disk 3 housed in the casing 2. A center core 4 with a central hole 5 is fixed to the disk 3 at the center thereof. Liners 10 for cleaning the surface of the disk 3 are bonded to the inner surface of the casing 2 at sites opposed to the disk 3.

In mobile instruments such as a digital camera, there has been used as the recording medium a miniature magnetic disk cartridge called “clik! ®” which is disclosed in U.S. Pat. No. 6,256,168. As shown in FIG. 3B, the disk cartridge (“clik! ®”) 11 comprises a 40 MB magnetic disk 13 1.8 inches (about 45.7 mm) in diameter housed in a flat metal casing 12. A center core 14 with a central hole 15 is fixed to the disk 13 at the center thereof.

In the disk cartridge 1 shown in FIG. 3A, the casing 2 is provided with an opening (not shown) which gives access to the disk 3 to a recording/reproducing head of a disk drive system into which the magnetic disk cartridge 1 is inserted, and a metal slide shutter (not shown) which is slid between its closed position where it closes the opening and its open position where it opens the opening is provided on the outer side of the casing 2. Whereas, in the disk cartridge 11 shown in FIG. 3B, the opening (not shown) which gives access to the disk 13 to a recording/reproducing head of a disk drive system is opened and closed by a metal rotary shutter 16 which is rotated between its closed position where it closes the opening and its open position where it opens the opening is provided on the inner side of the casing 12. Liners 20 for cleaning the surface of the disk 13 are bonded to the inner surface of the rotary shutter 16 at sites opposed to the disk 13.

Though the disk cartridge 11 shown in FIG. 3B is greatly smaller than that 1 shown in FIG. 3A as can be understood from the actual dimensions described above, both the cartridges are shown in substantially the same size for the purpose of simplification of understanding. Further, in both FIGS. 3A and 3B, the thickness is exaggerated.

That is, in the disk cartridges 1 and 11 described above, the liners 10 and 20 for cleaning the disks 3 and 13 are respectively applied to the inner surfaces of the casing 2 and the rotary shutter 16.

However, when a large impact is applied to the disk cartridge during storage of the same, the disk and the liner rub against each other and the disk can be damaged, which can result in deterioration of the properties of the cartridge. Especially, in the case of the disk cartridge 11 shown in FIG. 3B where the liner 20 is applied to the inner surface of the metal rotary shutter 16, the disk 13 undergoes a large impact when brought into contact with the liner 20 and is often damaged.

Conventionally, this problem has been dealt with by ensuring the clearance between the disk and the liner, improvement of elasticity of the surface of the liner and/or the like. However, the approach has not been satisfactory since the space in the disk cartridge becomes smaller due to a demand for a thinner disk cartridge and the approach adds to the cost.

### SUMMARY OF THE INVENTION

In view of the foregoing observations and description, the primary object of the present invention is to provide a disk cartridge which is improved in resistance to impact.

In accordance with the present invention, there is provided a disk cartridge comprising a casing in which a flexible information recording disk is housed, and a liner which is fixed to an inner surface of the casing or a shutter member interposed between the disk and the casing at a site opposed to the disk in order to clean the surface of the disk, wherein the improvement comprises that

the liner is supported away from the inner surface of the casing or the shutter member so that the liner can be deflected when the disk is brought into abutment against the liner due to impact applied to the disk cartridge.

For example, the liner may be supported on the inner surface of the casing or the shutter member by fixing the inner periphery and the outer periphery thereof respectively to an inner annular protrusion and an outer annular protrusion formed on the inner surface of the casing or the shutter member concentrically with the disk.

The liner is preferably formed of nonwoven fabric 40 to 80 μm in thickness and is further preferably lower in rigidity than the disk.

In accordance with the present invention, since the liner is supported away from the inner surface of the casing or the shutter member so that the liner can be deflected when the disk is brought into abutment against the liner, the impact applied to the disk cartridge is absorbed by the liner and accordingly, resistance to impact of the disk cartridge can be improved.

When the liner is supported by a protrusion formed on the inner surface of the casing or the shutter member, the performance of cleaning the surface of the disk by the liner can be readily adjusted by changing the height of the protrusion.

Further, when the liner is lower in rigidity than the disk, the cushioning performance of the liner is increased.

### BRIEF DESCRION OF THE DRAWINGS

FIGS. 1A and 1B are cross-sectional views respectively showing disk cartridges in accordance with first and second embodiments of the present invention,

FIGS. 2A and 2B are enlarged cross-sectional views for illustrating a result of the present invention, and

FIGS. 3A and 3B are cross-sectional views respectively showing conventional.

### DESCRIPTION OF THE PREFERRED EMBODIMENTS

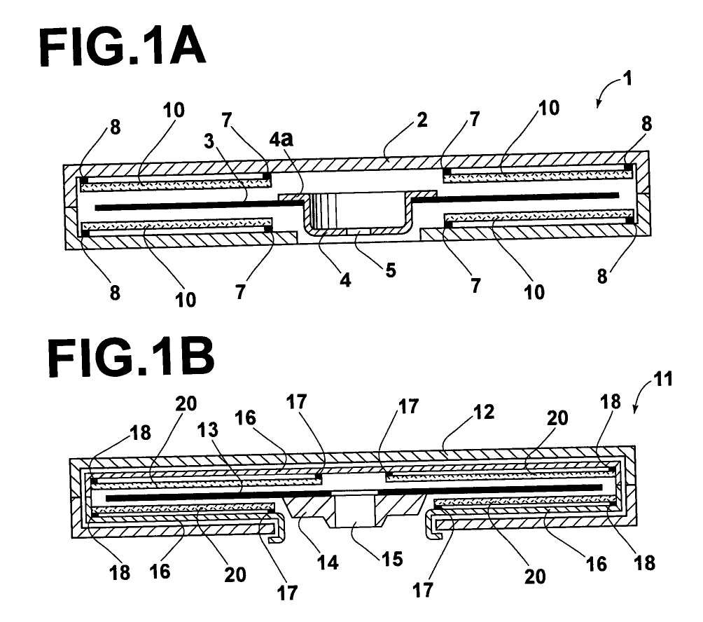

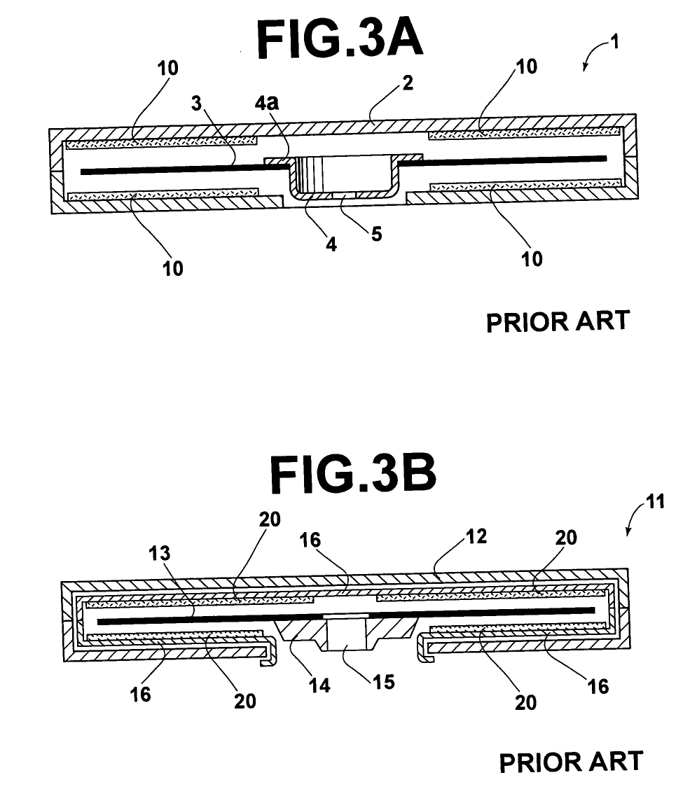

FIG. 1A shows a disk cartridge in accordance with a first embodiment of the present invention, where the present invention is applied to the disk cartridge shown in FIG. 3A, and FIG. 1B shows a disk cartridge in accordance with a second embodiment of the present invention, where the present invention is applied to the disk cartridge shown in FIG. 3B.

The disk cartridge 1 shown in FIG. 1A comprises a rectangular flat plastic casing 2 and a flexible disk 3 housed in the casing 2. A center core 4 with a central hole 5 is fixed to the disk 3 at the center thereof. Inner and outer annular protrusions 7 and 8 are formed on the inner surface of the casing 2 at sites opposed to the disk 3 concentrically with the disk 3. The inner annular protrusion 7 is positioned slightly outward of the outer edge of the flange 14a of the center core 4 and the outer annular protrusion 8 is positioned slightly outward of the outer edge of the disk 3. Liners 10 for cleaning the surface of the disk 3 are supported away from the inner surface of the casing 2 with the inner periphery and the outer periphery thereof respectively fixed to the inner annular protrusion 7 and the outer annular protrusion 8.

The disk cartridge 11 shown in FIG. 1B comprises a flat metal casing 12 and a flexible disk 13 housed in the casing 12. A center core 14 with a central hole 15 is fixed to the disk 13 at the center thereof. A metal rotary shutter 16 is provided for rotation inside the casing 12. Inner and outer annular protrusions 17 and 18 are formed on the inner surface of the rotary shutter 16 at sites opposed to the disk 13 concentrically with the disk 13. The outer annular protrusion 18 is positioned slightly outward of the outer edge of the disk 13. Liners 20 for cleaning the surface of the disk 13 are supported away from the inner surface of the rotary shutter 16 with the inner periphery and the outer periphery thereof respectively fixed to the inner annular protrusion 17 and the outer annular protrusion 18.

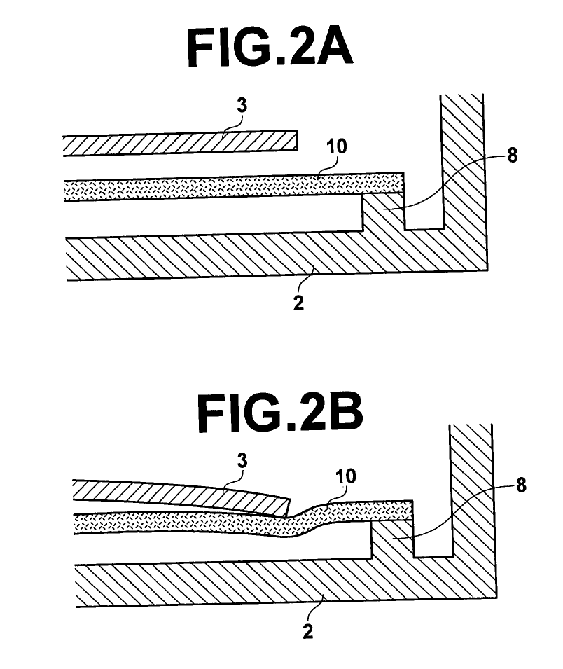

FIGS. 2A and 2B are enlarged cross-sectional views for illustrating a result of the present invention. That is, the outer peripheral portion of the liner 10 is supported by the outer annular protrusion 8 as shown in FIG. 2A. When a large impact is applied to the disk cartridge 1 in the state shown in FIG. 2A, the disk 3 can abut against the liner 10, and the liner 10 can be deflected to absorb the impact as shown in FIG. 2B.

The liner 10 is preferably made of acrylic nonwoven fabric (e.g., SHALERIA available from ASAHI KASEI), nonwoven fabric of material including cotton (e.g., Bemilies available from ASAHI KASEI) or polyethylene nonwoven fabric (e.g., Sanmap available from KYOUSHISHA).

The liner 10 is preferably 40 to 80 μm in thickness and is preferably not higher than 60% of the disk 3 in rigidity.

As can be understood from the description above, the disk cartridges of the first and second embodiments of the present invention are excellent in resistance to impact since the liner 10 or 20 is deflected when an impact is applied to the disk cartridge to absorb the impact.

Since the liner 10 or 20 is supported by protrusions 7 and 8 or 17 and 18 formed on the inner surface of the casing 2 or the rotary shutter 16, the performance of cleaning the surface of the disk by the liner can be readily adjusted by changing the height of the protrusions.

Further, since the liner is lower in rigidity than the disk, the cushioning performance of the liner is increased.

What is claimed is:

1. A disk cartridge comprising a casing in which a flexible information recording disk is housed, and a liner which is fixed to an inner surface of the casing or a shutter member interposed between the disk and the casing at a site opposed to the disk in order to clean the surface of the disk, wherein the improvement comprises that
the liner is supported away from the inner surface of the casing or the shutter member so that the liner can be deflected when the disk is brought into abutment against the liner due to impact applied to the disk cartridge.

2. A disk cartridge as defined in claim 1 in which the liner is supported on the inner surface of the casing or the shutter member by way of a protrusion formed on the inner surface of the casing or the shutter member.

3. A disk cartridge as defined in claim 2 in which the liner is supported on the inner surface of the casing or the shutter member by fixing the inner periphery and the outer periphery thereof respectively to an inner annular protrusion and an outer annular protrusion formed on the inner surface of the casing or the shutter member concentrically with the disk.

4. A disk cartridge as defined in claim 2 in which the liner is formed of nonwoven fabric 40 to 80 μm in thickness.

5. A disk cartridge as defined in claim 2 in which the liner is lower in rigidity than the disk.

6. A disk cartridge as defined in claim 1 in which the liner is formed of nonwoven fabric 40 to 80 μm in thickness.

7. A disk cartridge as defined in claim 1 in which the liner is lower in rigidity than the disk.
